(19) United States
(12) Patent Application Publication
(10) Pub. No.: US 2011/0289247 A1
(43) Pub. Date: Nov. 24, 2011

(54) Autonomous positional addressing in stacked multi-board systems

(75) Inventor: Allan V. Burklund, Tucson, AZ (US)

(73) Assignee: National Semiconductor Corporation, Santa Clara, CA (US)

(21) Appl. No.: 12/800,751

(22) Filed: May 21, 2010

(51) Int. Cl. G06F 13/38

(52) U.S. Cl. 710/107

(57) ABSTRACT

A method includes receiving a first address over an address bus at a first module, modifying the first address to generate a second address, and transmitting the second address over the address bus to a second module. The method also includes determining at the first module if at least one of the first and second addresses has a specified value. Modifying the first address could include incrementing or decrementing the first address to generate the second address. Determining if at least one of the first and second addresses has the specified value could include determining if the first address has a value of zero or a value of 2ⁿ−1 (where n is a specified number of bits in the address bus). Each module by design may be inserted into any position in a stack relative to a controller and be positionally selected without manual configuration of that module's address.

### TECHNICAL FIELD

This disclosure is generally directed to digital electronic addressing systems. More specifically, this disclosure relates to autonomous positional addressing in stacked multi-board systems.

### BACKGROUND

Many computing, communication, and other systems use multiple circuit boards that are stacked on top of each other or connected in a similar manner. Each circuit board then typically communicates with or through the adjacent circuit board(s) in the stack. For example, a stack could include a controller board, a power supply board, and multiple circuit boards that may or may not be identical.

In conventional systems, each circuit board is assigned an address so that the controller board can communicate with specific circuit boards. In some configurations, specialized hardware is used to assign an address to each of the circuit boards, such as dip switches that are manually set. In other configurations, highly specialized configuration software is used on the controller board and each circuit board to determine the addresses and acquire the positions of the circuit boards within the stack. Moreover, each circuit board typically requires specialized decoding and comparing circuitry in order to receive an address and determine whether the received address matches the circuit board's address. All of this typically increases the cost of designing, manufacturing, installing, and maintaining the boards in a stack.

### BRIEF DESCRIPTION OF THE DRAWINGS

For a more complete understanding of this disclosure and its features, reference is now made to the following description, taken in conjunction with the accompanying drawings, in which:

FIG. 1 illustrates an example stacked multi-board system according to this disclosure;

FIG. 2 illustrates an example autonomous positional addressing technique in a stacked multi-board system according to this disclosure;

FIGS. 3 through 11 illustrate example addressing circuits supporting autonomous positional addressing and related details according to this disclosure;

FIGS. 12 and 13 illustrate a more specific example of a stacked multi-board system according to this disclosure; and

FIG. 14 illustrates an example method for autonomous positional addressing in a stacked multi-board system according to this disclosure.

### DETAILED DESCRIPTION

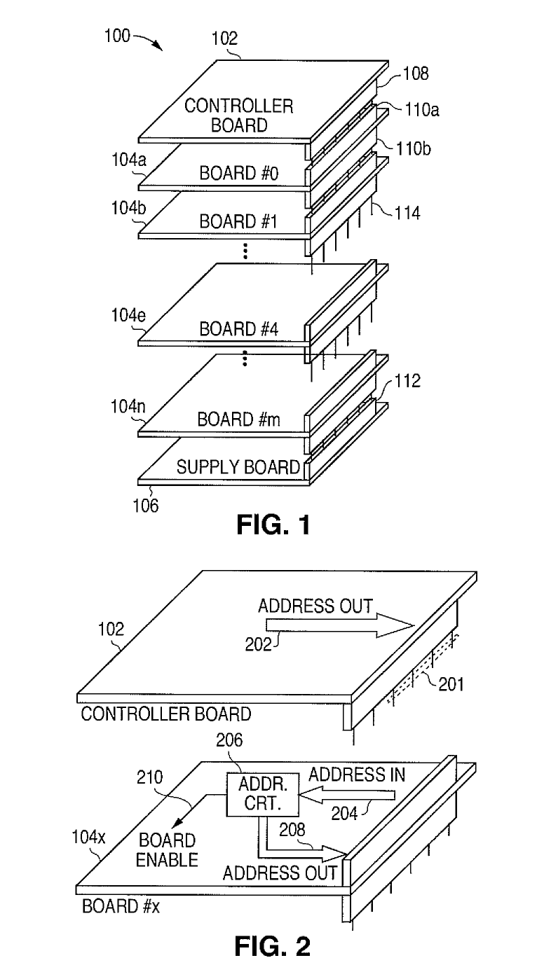

FIGS. 1 through 14, discussed below, and the various embodiments used to describe the principles of the present invention in this patent document are by way of illustration only and should not be construed in any way to limit the scope of the invention. Those skilled in the art will understand that the principles of the invention may be implemented in any type of suitably arranged device or system.

FIG. 1 illustrates an example stacked multi-board system 100 according to this disclosure. As shown in FIG. 1, the system 100 includes multiple boards that are placed on top of each other and electrically interconnected to form a stack. The boards include a controller board 102, multiple circuit boards 104a-104n, and a power supply board 106. The circuit boards 104a-104n generally represent printed circuit boards (PCBs) or other structures that carry circuitry for performing one or more functions. The circuit boards 104a-104n could represent identical circuit boards carrying the same circuitry, or the circuit boards 104a-104n could include different circuits for performing different functions. The controller board 102 monitors or controls the operation of the circuit boards 104a-104n. As a particular example, the system 100 could represent an embedded control system that uses a single controller board to access and control multiple circuit boards. The power supply board 106 supplies operating power to other boards in the system.

The controller board 102 includes any suitable module containing circuitry or other components that monitor or control one or more circuit boards or other controlled modules. Each circuit board 104a-104n includes any suitable module containing circuitry that performs one or more desired functions. The power supply board 106 includes any suitable module containing components for supplying power to other boards in a system.

In this example, the controller board 102 includes a connector 108 that electrically couples the controller board 102 to an adjacent circuit board in the stack. Also, each circuit board 104a-104n includes two connectors 110a-110b that electrically couple that circuit board to adjacent boards in the stack. In addition, the power supply board 106 includes a connector 112 that electrically couples the power supply board 106 to an adjacent circuit board in the stack. Each of the connectors 108, 110a-110b, 112 represents any suitable structure for electrically coupling two printed circuit boards or other structures. For instance, each connector under a board in FIG. 1 could include multiple pins 114, and each connector above a board in FIG. 1 could include recesses for receiving multiple pins 114. However, any other suitable structures could be used to electrically couple boards in a stack.

In conventional systems, each circuit board 104a-104n would typically require specialized hardware to set the address of that circuit board (such as dip switches), as well as circuitry to determine whether a received address matches the circuit board's address (such as decoders and comparators). Additionally, the controller board 102 would require specialized configuration software in order to link the addresses of the circuit boards 104a-104n to their locations within the stack.

In accordance with this disclosure, the controller board 102 views each circuit board 104a-104n as having an address based on that circuit board's position in the stack. For example, the controller board 102 could view the circuit board 104a in position #0 as having an address of “0000,” the circuit board 104b in position #1 as having an address of “0001,” and so on. If there are sixteen circuit boards, the controller board 102 could view the circuit board in position #15 as having an address of “1111.” Each circuit board 104a-104n in the stack can therefore be selected by the controller board 102 based on the position that circuit board occupies. Each circuit board 104a-104n could be inserted at any position in the stack and be enabled by and respond to a new positional address without any configuration.

To facilitate this functionality, each circuit board 104a-104n supports an autonomous positional addressing technique. FIG. 2 illustrates an example autonomous positional addressing technique in a stacked multi-board system according to this disclosure. In this example, the circuit boards 104a-104n operate to dynamically modify the address being sent over an address bus 201 from the controller board 102 through the circuit boards 104a-104n. The address bus 201 represents a collection of one or more signal lines through the connectors 108, 110a-110b. In some embodiments, the address bus 201 is formed by four signal lines, which allows up to sixteen addresses (and therefore up to sixteen circuit boards) to be used in the system 100.

As shown in FIG. 2, when the controller board 102 wishes to communicate with a specified circuit board, the controller board 102 transmits an output address 202 over the address bus 201. The output address 202 identifies the position in the stack of the circuit board being selected. For instance, if the target circuit board is the circuit board 104e in position #4, the output address 202 could equal 0100.

Each circuit board 104x in the stack receives an input address 204 from either the prior circuit board or the controller board 102. That circuit board 104x then modifies the received address 204 using an addressing circuit 206, which outputs the modified address to the next circuit board (if any) as an output address 208. The addressing circuit 206 also determines if the received or modified address 204 or 208 equals a specified value. If so, the addressing circuit 206 determines that the circuit board 104x is being selected (meaning a communication is intended for that board), and the addressing circuit 206 triggers a board enable signal 210. The board enable signal 210 identifies whether the addressing circuit 206 determines that its circuit board is being selected over the address bus 201.

In some embodiments, the addressing circuit 206 in each circuit board 104a-104n receives the input address 204 and decrements or subtracts a value of one from the address 204 to generate the output address 208. Also, the addressing circuit 206 in each circuit board 104a-104n triggers the board enable signal 210 when the received address 204 equals zero (0000).

As an example, assume the controller board 102 wishes to transmit data to the circuit board 104e in position #4. The controller board 102 outputs an address 202 of 0100 over the address bus 201. The first circuit board 104a receives an address 204 of 0100 over the address bus 201, determines that the address 204 is not 0000, decrements the address value, and outputs an address 208 of 0011. The second circuit board 104b receives an address 204 of 0011 over the address bus 201, determines that the address 204 is not 0000, decrements the address value, and outputs an address 208 of 0010. The third and fourth circuit boards would decrement the address value to 0001 and 0000, respectively. The fifth circuit board 104e receives an address 204 of 0000 over the address bus 201, determines that the address 204 is 0000, and triggers the board enable signal 210. The fifth circuit board 104e could also output an address 208 of 1111 (caused by subtracting one from a value of zero), and the subsequent circuit boards would receive non-zero addresses 204 and not be enabled.

In this example, the fifth circuit board 104e is successfully selected by the controller board 102 without requiring any manual configuration of the fifth circuit board 104e to have an address of 0100. Instead, each circuit board 104a-104n is effectively set to use an address of 0000, meaning each circuit board 104a-104n views itself as having an address of 0000. The addressing circuits 206 in the circuit boards 104a-104n operate to ensure that only one circuit board receives an address of 0000, regardless of the specific address 202 output by the controller board 102.

In this way, no external backplane is required, and no customization hardware is needed. Also, this approach eliminates the need for manual board configuration since systems implementing this approach can accept a circuit board 104a-104n in any position within a stack without concern for incorrect addressing. Only one circuit board may respond when the controller board 102 asserts a specified value on the address bus 201. With the controller board 102 placed at one end of the stack in FIG. 1, there is no need for the controller board 102 to acquire the position of each circuit board 104a-104n within the stack. This approach therefore reduces design time, hardware and firmware requirements, system costs, and installation problems. Not only that, using a circuit board's position as its address allows personnel to more quickly identify which board is generating alerts or has failed, and no translation of a board's address to its physical position needs to be performed.

Note that the subtraction of one from the input address 204 to generate the output address 208 is for illustration only. Any other suitable technique could be used by the addressing circuits 206. For instance, the addressing circuit 206 in each circuit board 104a-104n could increment or add a value of one to the address 204 in order to generate the output address 208. Also, values other than one could be added to or subtracted from the input address 204 to generate the output address 208. Further, the comparison of the input address 204 to a value of 0000 is for illustration only. Each circuit board 104a-104n could determine whether its input address 204 or its output address 208 has any suitable value (such as 1111, or more generally 2ⁿ−1 where n is a specified number of bits in the address bus 201). In addition, while four-bit address values are used here, the address values 202, 204, 208 could have any suitable number of bits.

Additional details regarding the dynamic modification of an address being sent on an address bus through multiple circuit boards are provided below. These examples are for illustration only and assume that a value of one is added to or subtracted from an input address 204 to generate an output address 208 in each addressing circuit 206. As noted above, other embodiments of the addressing circuit 206 could be used.

Although FIG. 1 illustrates one example of a stacked multi-board system, various changes may be made to FIG. 1. For example, the system 100 could use any number of circuit boards 104a-104n, and the power supply board 106 could have any position within the stack. However, the controller board 102 may always reside at one end of the multi-board stack that is to be addressed. Although FIG. 2 illustrates one example of an autonomous positional addressing technique, various changes may be made to FIG. 2. For instance, as noted above, the addressing circuit 206 could generate the output address 208 in various ways and determine whether the input address 204 has any specified value.

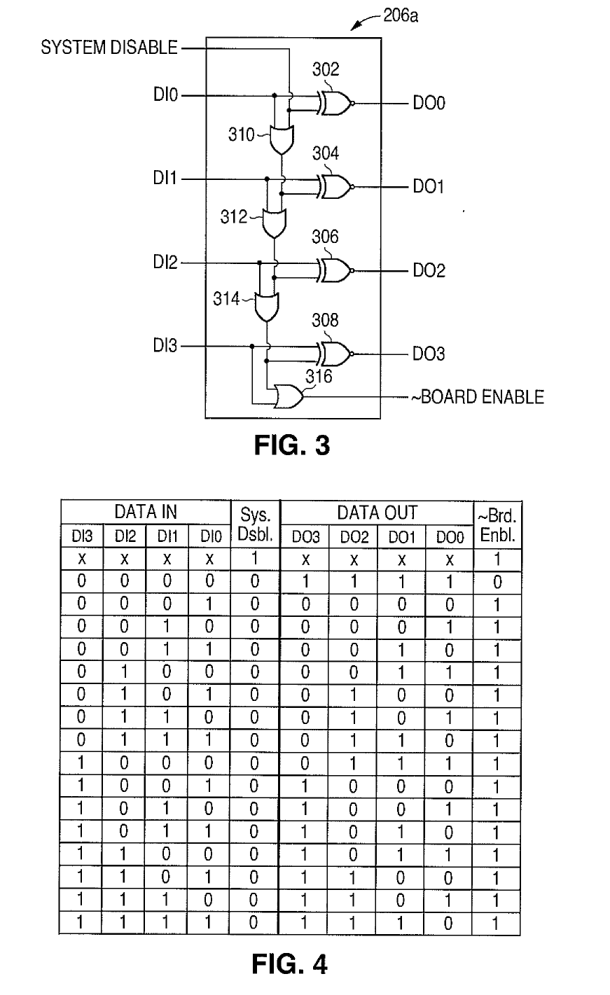

FIGS. 3 through 11 illustrate example addressing circuits supporting autonomous positional addressing and related details according to this disclosure. In particular, FIGS. 3 through 11 illustrate different example implementations of the addressing circuit 206 in the circuit boards 104a-104n, as well as the operation of those addressing circuits.

In FIG. 3, an addressing circuit 206a includes four XOR gates 302-308 and four OR gates 310-316. Each XOR gate 302-308 includes any suitable structure for performing a logical exclusive OR operation. Each OR gate 310-316 includes any suitable structure for performing a logical OR operation.

The addressing circuit 206a here represents an adder that adds a value of −1 (1111 in two's complement notation) to an input value (the input address 204) in order to generate an output value (the output address 208). This decrements the input address 204 by one each time the address passes through a circuit board. The input address 204 is defined by bits DI3-DI0, and the output address 208 is defined by bits DO3-DO0.

The XOR gate 302 receives an input bit DI0 and a system disable bit (which corresponds to a “carry in” bit of the adder) and generates an output bit DO0. The XOR gate 304 receives an input bit DI1 and an output of the OR gate 310 and generates an output bit DO1. The XOR gate 306 receives an input bit DI2 and an output of the OR gate 312 and generates an output bit DO2. The XOR gate 308 receives an input bit DI3 and an output of the OR gate 314 and generates an output bit DO3. The OR gates 310-316 operate to generate a ˜board enable bit (which corresponds to a “carry out” bit of the adder) based on the five input values. The ˜ notation is used here to denote that the circuit board is enabled (i.e. addressed/selected) when the board enable bit has a low value. This notation is not used with the system disable bit since the circuit board is disabled when the system disable bit is high.

In this example, the board enable bit has a value of zero when the addressing circuit 206a receives an input address equal to 0000 and the system disable bit is 0; otherwise, the board enable bit has a value of one. The system disable bit can be set to a value of one in order to force the addressing circuit 206a to output a board enable bit with a value of one (thereby disabling the circuit board).

A truth table illustrating the operation of the addressing circuit 206a is presented in FIG. 4. As shown in FIG. 4, the ˜board enable bit has a value of zero only when the input value is 0000 and the system disable bit has a value of zero. This may occur, for example, when the addressing circuit 206a is used in a circuit board that is being selected, i.e. the preceding circuit board or controller board has provided an address of 0000 on the address bus 201.

Note that the complexity of the adder circuitry shown in FIG. 3 is simplified by the fact that the circuit adds a constant (1111) to the input value, which is equivalent to subtracting one. Of course, the circuit in FIG. 3 could be modified to add a different value to the input address. Moreover, note that the board enable bit would be set to zero only when all five input bits are zero. This allows the simple triggering of the board enable bit using only OR operations, which eliminates the need for complex decoding and comparison circuits. However, it is possible with a different circuit to trigger the board enable bit in response to other input values. In addition, the system disable input in multiple circuit boards 104a-104n could be tied to the controller board 102, allowing the controller board 102 to easily disable all circuit boards 104a-104n. This can be used, for instance, to prevent the inadvertent addressing of a circuit board.

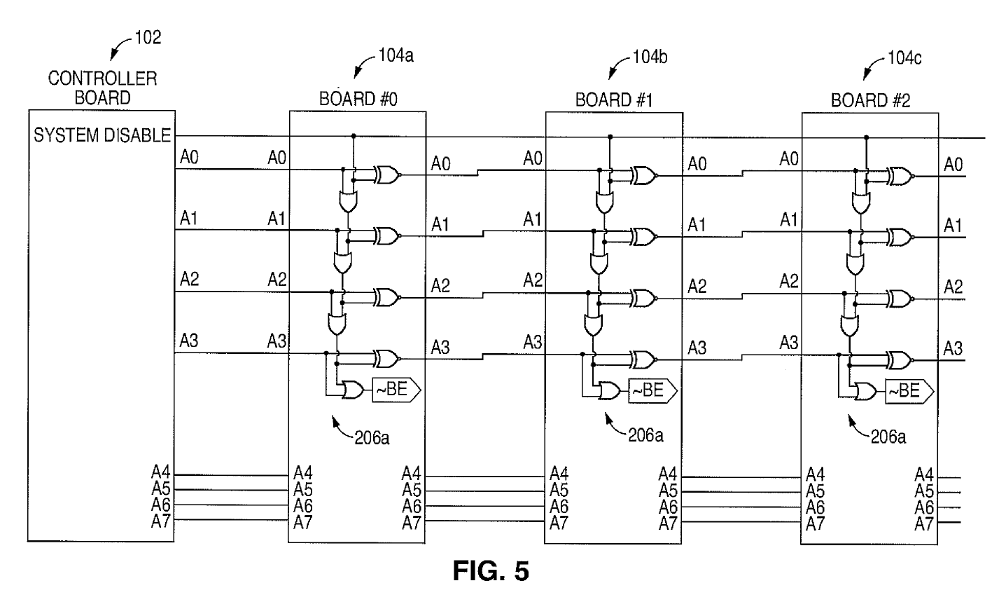

FIG. 5 illustrates the use of the addressing circuit 206a in three consecutive circuit boards 104a-104c, which are coupled in series to the controller board 102. In this example, the controller board 102 can output a system disable signal, which disables all circuit boards 104a-104c (meaning no circuit board determines that it is being selected over the address bus). Also, in this example, the address bus may be formed by eight bits A7-A0, and the addressing circuit 206a may operate only on the lower four bits of the address bus. This simply illustrates that the addressing circuits 206a need not handle all bits of an address.

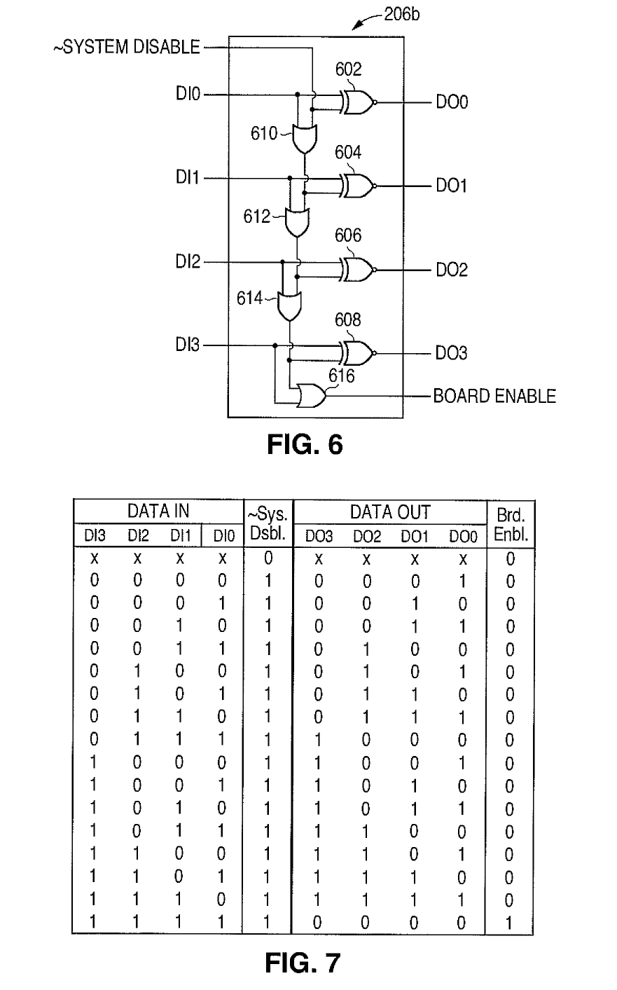

While FIGS. 3 through 5 illustrate the decrementing of an address as the address traverses through each circuit board 104a-104n, other approaches could be used. FIG. 6 illustrates an example addressing circuit 206b that includes four XOR gates 602-608 and four AND gates 610-616. Each AND gate 610-616 includes any suitable structure for performing a logical AND operation.

The addressing circuit 206b here represents an adder that adds a value of +1 (0001) to an input value (the input address 204) in order to generate an output value (the output address 208). Also, the addressing circuit 206b determines that its circuit board is being selected when the input address 204 equals 1111. Here, the circuit board closest to the controller board 102 may be said to reside in position #15, while the circuit board farthest from the controller board 102 may be said to reside in position #0.

The XOR gate 602 receives an input bit DI0 and a ˜system disable bit and generates an output bit DO0. The ˜ notation indicates that the system is disabled when a low system disable value is received. The XOR gate 604 receives an input bit DI1 and an output of the AND gate 610 and generates an output bit D01. The XOR gate 606 receives an input bit DI2 and an output of the AND gate 612 and generates an output bit DO2. The XOR gate 608 receives an input bit D13 and an output of the AND gate 614 and generates an output bit DO3. The AND gates 610-616 operate to generate a board enable bit, which is high when the circuit board is selected, based on the five input values.

A truth table illustrating the operation of the addressing circuit 206b is presented in FIG. 7. As shown in FIG. 7, the board enable bit has a value of one only when the input value is 1111 and the ˜system disable bit has a value of one. This may occur, for example, when the addressing circuit 206b is used in a circuit board that is being selected, i.e. the preceding circuit board or controller board has provided an address of 1111 on the address bus 201. It also shows that a value of zero can be used as the ˜system disable bit to disable the addressing circuit 206b (forcing the board enable bit to zero).

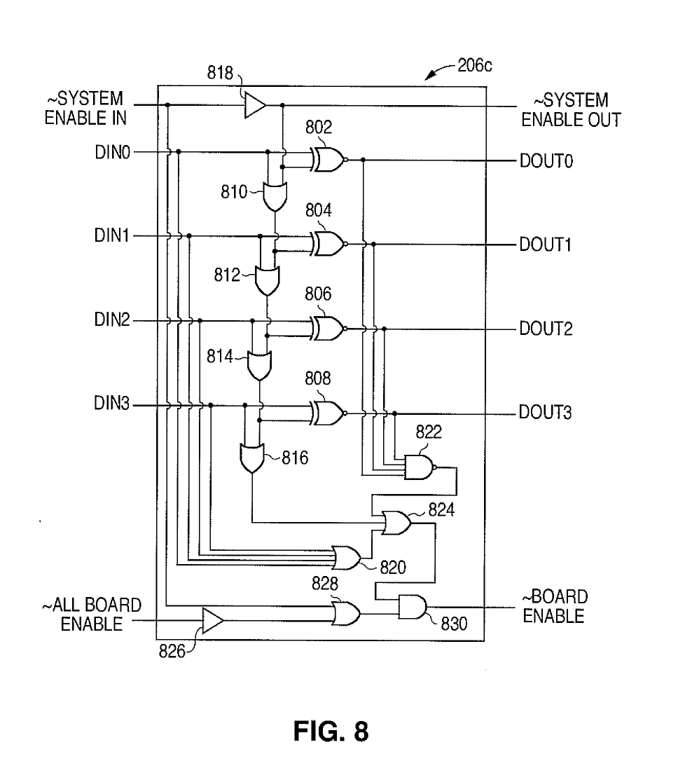

FIG. 8 illustrates an addressing circuit 206c that subtracts one from an input address 204 to generate an output address 208. The addressing circuit 206c includes XOR gates 802-808 and OR gates 810-816 in the same arrangement as shown in FIG. 3. The addressing circuit 206c also includes a buffer 818, which buffers a ˜system enable input (which is low when the system is enabled and high when the system is disabled).

The addressing circuit 206c further includes circuitry to prevent jitter on a ˜board enable bit when a new address ripples through the system. In addition, the addressing circuit 206c supports the use of an ˜all board enable bit, which can be used by the controller board 102 to enable all circuit boards 104a-104n. This allows all circuit boards 104a-104n to be selected simultaneously. When the ˜all board enable bit is low, all circuit boards are enabled; when the ˜all board enable bit is high, the circuit boards are selected individually.

The additional circuitry includes a four-input OR gate 820 that receives the input bits DIN3-DIN0 and a four-input NAND gate 822 that receives the output bits DOUT3-DOUT0. The outputs of the OR gate 816, the OR gate 820, and the NAND gate 822 are provided to a three-input OR gate 824. A buffer 826 buffers the ˜all board enable bit, and an OR gate 828 receives the buffered ˜all board enable bit and the ˜system enable input bit. An AND gate 830 receives the outputs of the OR gates 824 and 828 and generates a ˜board enable bit.

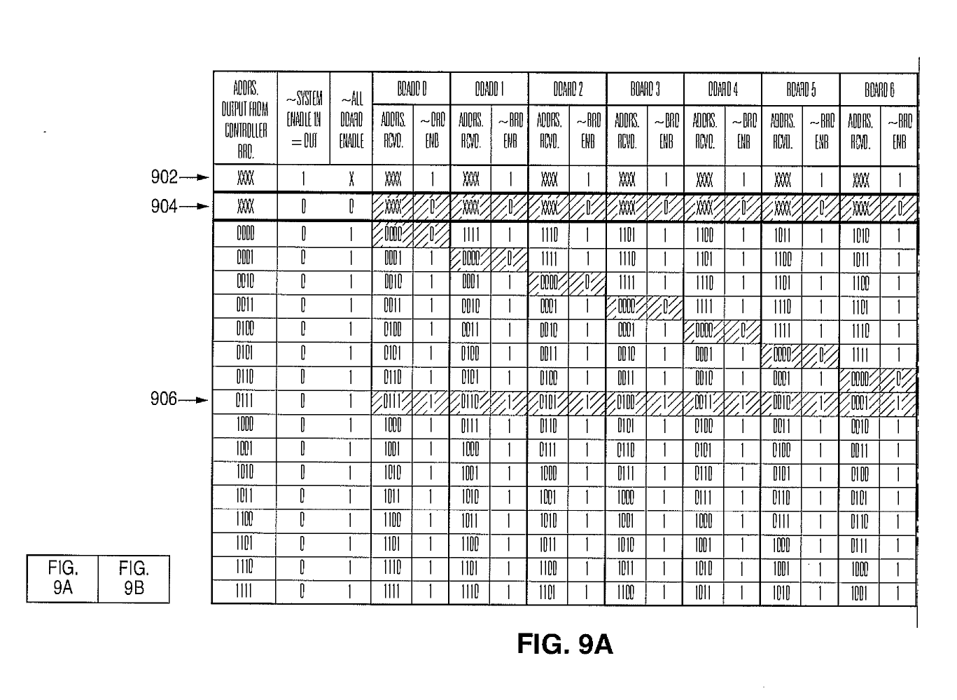

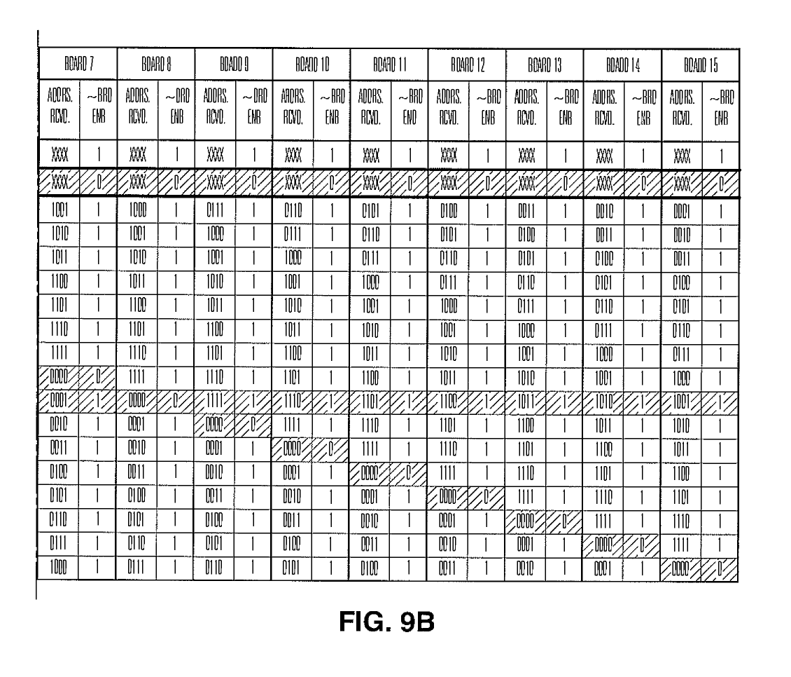

A truth table illustrating the operation of the addressing circuit 206c is presented in FIG. 9. As shown in row 902, if the ˜system enable bit has a value of one, each circuit board 104a-104n outputs a ˜board enable bit with a value of one (meaning no circuit boards 104a-104n are being selected). As shown in row 904, if the ˜system enable bit has a value of zero and the ˜all board enable bit has a value of zero, each circuit board 104a-104n outputs a ˜board enable bit with a value of zero, which enables all of the circuit boards 104a-104n.

The remaining rows show how an address is decremented as it is passes through the circuit boards 104a-104n. This is done to individually address the circuit boards 104a-104n. For example, row 906 illustrates how an address of 0111 output by the controller board 102 is decremented by the circuit boards from position #0 through position #6, and a value of 0000 is received by the circuit board in position #7 (meaning that circuit board is being selected). The succeeding circuit board in position #8 has an address of 1111 (since the subtraction causes the address value to roll over from 0000 to 1111), so the following boards have addresses of 1111, 1110, 1101, and so on. Only the circuit board in position #7 has its ˜board enable bit set to zero, indicating that it is the only circuit board being selected as indicated by the 0111 address value output by the controller board 102.

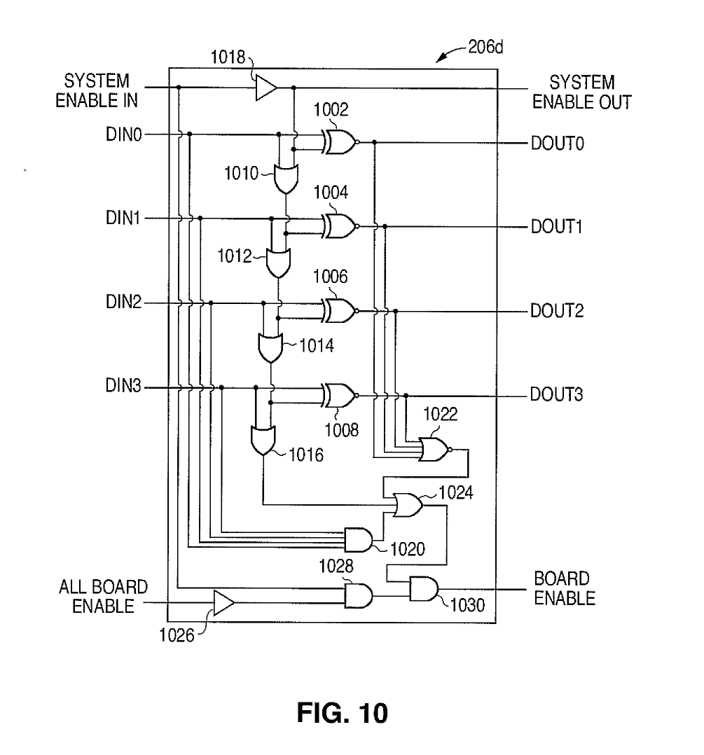

FIG. 10 illustrates an addressing circuit 206d that adds a value of one to an input address 204 to generate an output address 208. The addressing circuit 206d includes XOR gates 1002-1008 and AND gates 1010-1016 in the same arrangement as shown in FIG. 6. The addressing circuit 206d also includes a buffer 1018, which buffers a system enable input bit (which is high when the system is enabled and low when the system is disabled).

The addressing circuit 206d further includes circuitry to prevent jitter on a board enable bit when a new address ripples through the system. In addition, the addressing circuit 206d supports the use of an all board enable bit. When the all board enable bit is high, all circuit boards are enabled; when the all board enable bit is low, the circuit boards are selected individually.

The additional circuitry includes a four-input AND gate 1020 that receives the input bits DIN3-DIN0 and a four-input NOR gate 1022 that receives the output bits DOUT3-DOUT0. The outputs of the AND gate 1016, the AND gate 1020, and the NOR gate 1022 are provided to a three-input OR gate 1024. A buffer 1026 buffers the all board enable bit, and an AND gate 1028 receives the all board enable bit and the system enable input bit. An OR gate 1030 receives the outputs of the OR gate 1024 and the AND gate 1028.

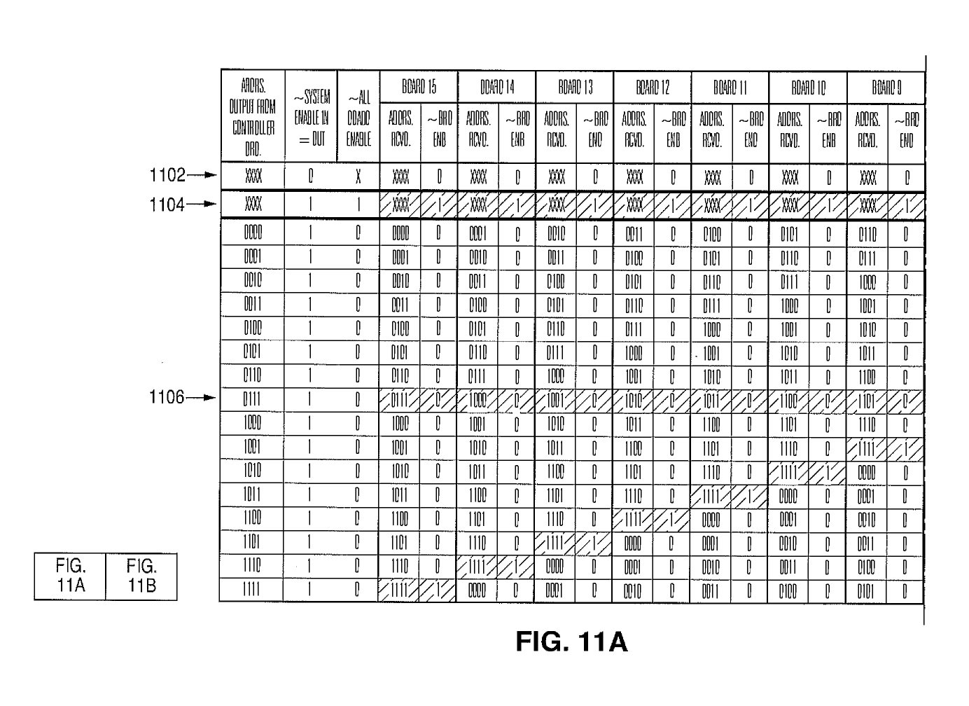

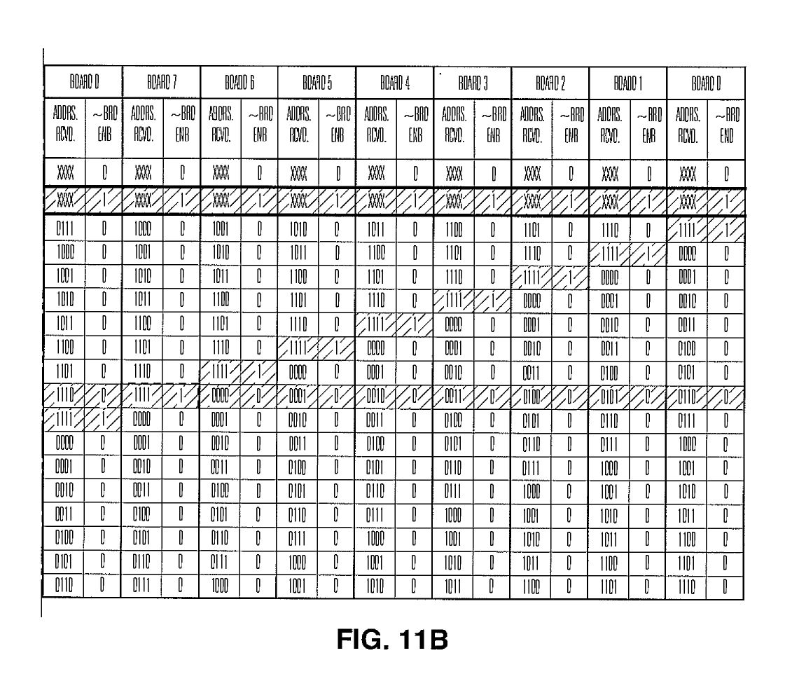

A truth table illustrating the operation of the addressing circuit 206d is presented in FIG. 11. As shown in row 1102, if the system enable input bit has a value of zero, each circuit board 104a-104n outputs a board enable bit with a value of zero, which disables all of the circuit boards 104a-104n. As shown in row 1104, if the system enable input bit has a value of one and the all board enable bit has a value of one, each circuit board 104a-104n outputs a board enable bit with a value of one, which enables all of the circuit boards 104a-104n.

The remaining rows show how an address is incremented as it is passes through the circuit boards 104a-104n. This is done to individually address the circuit boards 104a-104n. For example, row 1106 illustrates how an address of 0111 output by the controller board 102 is incremented by the circuit boards from position #15 through position #8 until a value of 1111 is received by the circuit board in position #7 (meaning that circuit board is being selected). The next circuit board in position #6 receives an address of 0000 (since the addition of one causes the address value to roll over from 1111 to 0000), and the following boards have addresses of 0001, 0010, 0011, and so on. Only the circuit board in position #7 has its board enable bit set to one, indicating that it is the only circuit board being selected as indicated by the 0111 address value output by the controller board 102.

Although FIGS. 3 through 11 illustrate examples of addressing circuits supporting autonomous positional addressing and related details, various changes may be made to FIGS. 3 through 11. For example, addressing circuits that operate in other ways could also be used. This can include addressing circuits that add or subtract other values to generate an output address 208, as well as addressing circuits that determine whether the input address 204 or output address 208 has a different specified value other than 0000 or 1111.

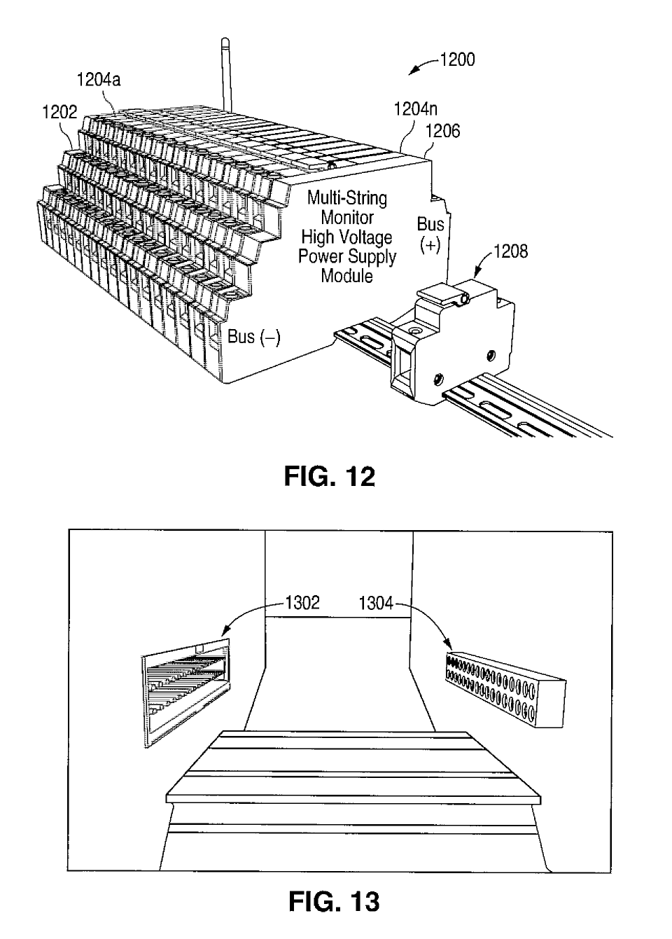

FIGS. 12 and 13 illustrate a more specific example of a stacked multi-board system 1200 according to this disclosure. In particular, FIG. 12 illustrates an example multi-board system 1200, and FIG. 13 illustrates an example interface coupling adjacent boards in the system 1200.

As shown in FIG. 12, the stacked multi-board system 1200 includes a controller module 1202, multiple string monitor modules 1204a-1204n, and a high-voltage power supply module 1206. The string monitor modules 1204a-1204n represent structures used to monitor and control strings of photovoltaic panels (solar cells). Each string monitor module 1204a-1204n could, for example, acquire power, current, or voltage data for at least one string of photovoltaic panels. Each string monitor module 1204a-1204n could, for instance, perform maximum power point tracking operations or other operations to adjust and control at least one string of photovoltaic panels. Each string monitor module 1204a-1204n could further include an integrated fuse that can trip to break an electrical connection to at least one string. A fuse 1208 could also be provided for the combined output of the strings. The controller module 1202 collects power, current, or voltage data from the modules 1204a-1204n and detects problems or other issues with the modules 1204a-1204n. The controller module 1202 in this example includes a wireless transceiver facilitating wireless communications, such as with an external control system.

Each string monitor module 1204a-1204n includes positive and negative terminals for coupling that module to at least one string of photovoltaic cells. Each string monitor module 1204a-1204n also includes positive and negative bus terminals for coupling those modules 1204a-1204n to external inverter hardware connected to a utility grid or other electrical distribution or storage system. The power supply module 1206 taps power from the power bus and provides power to the modules 1204a-1204n and the controller module 1202.

The components 1202-1206 here form a stack (although the stack is arranged sideways instead of up and down). Each string monitor module 1204a-1204n includes one of the addressing circuits shown and described above to support autonomous positional addressing. Each string monitor module 1204a-1204n could be inserted at any position between the controller module 1202 and the power supply module 1206. The controller module 1202 could then output an address over an address bus based on the position of a particular string monitor module, and only that particular string monitor module may view itself as being selected. The controller module 1202 could also use an all board enable signal to enable all modules 1204a-1204n and a system disable/enable bit to disable all modules 1204a-1204n.

FIG. 13 illustrates a system bus that can be used to interconnect adjacent modules in the system 1200. For example, a module could include a shrouded header 1302 containing pins, and the pins of the shrouded header 1302 could be inserted into a socket 1304 of another module. The system bus formed in this manner could include an address bus of any suitable width, and the modules 1204a-1204n could modify an address sent over the address bus as described above.

As a particular example implementation, the system 1200 could be used in a solar farm having any number of photovoltaic strings, such as a 5 MW solar farm having 1,000 photovoltaic strings. In conventional systems, each string might have an associated string monitor module, and those string monitor modules could be grouped into over sixty stacks. Each string monitor module would typically need to have an address, which means that 1,000 different modules would need to have their addresses assigned individually. In accordance with this disclosure, each string monitor module 1204a-1204n can be inserted into any stack and be selected by the associated controller module based on its position in the stack, without the need to manually assign an address to that module.

Although FIGS. 12 and 13 illustrate one more specific example of a stacked multi-board system 1200, various changes may be made to FIGS. 12 and 13. For example, the system 1200 shown in FIG. 12 could include any number of controller, string monitor, and power supply modules. Also, the system bus shown in FIG. 13 could have any other suitable structure.

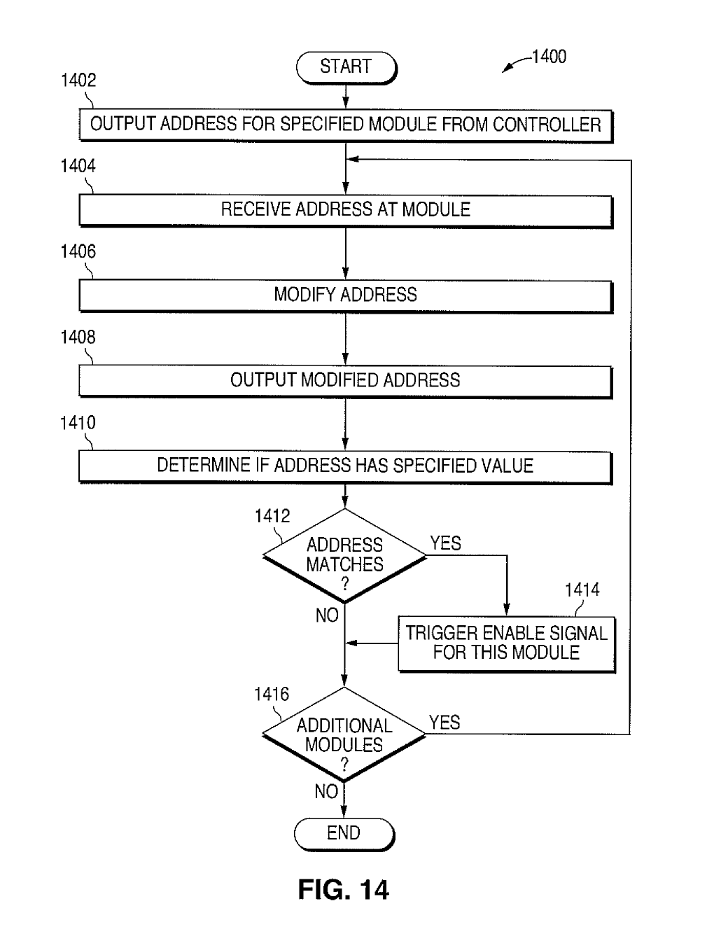

FIG. 14 illustrates an example method 1400 for autonomous positional addressing in a stacked multi-board system according to this disclosure. As shown in FIG. 14, a controller outputs an address for a specified module at step 1402. This could include, for example, the controller board 102 outputting an address 202 on the address bus 201, where the address 202 is based on the position of the specific circuit board 104a-104n being selected. The controller board 102 could have previously identified the position of each individual circuit board in the stack using any suitable technique, such as by individually addressing each position and analyzing a response (if any) to determine which circuit board 104a-104n is located in each position.

The address from the controller is received at a first module at step 1404. This could include, for example, the circuit board 104a adjacent to the controller board 102 receiving the address 204 over the address bus 201. That module modifies the address at step 1406 and outputs the modified address at step 1408. This could include, for example, the addressing circuit 206 in the module incrementing the address 204 by one, decrementing the address 204 by one, or otherwise altering the address 204 to generate the address 208. This could also include the addressing circuit 206 outputting the modified address 208 on the address bus 201. In this way, the address sent over the address bus 201 is dynamically modified as it traverses through the circuit boards 104a-104n.

The module also determines if at least one of the addresses has a specified value at step 1410. This could include, for example, the addressing circuit 206 determining whether the address 204 has a value of 0000 or 1111. If at least one address has the specified value at step 1412, this indicates that the module is being selected, and the enable signal for this module is triggered at step 1414. In this way, the circuit board can determine whether it is being selected by the dynamically modified address.

If additional modules remain (meaning the dynamically modified address has not reached the last addressable module in the stack), the method returns to step 1404, and steps 1404-1414 are repeated for the next module in the stack, which now uses the address output from the prior module instead of from the controller. This process can continue until all addressable modules in the stack have received the address from a prior module.

Although FIG. 14 illustrates one example of a method 1400 for autonomous positional addressing in a stacked multi-board system, various changes may be made to FIG. 14. For example, while shown as a series of steps, various steps in FIG. 14 may overlap, occur in parallel, or occur in a different order. Also, the use of a system disable/enable signal and an all board enable signal could be supported.

In some embodiments, various functions described above are implemented or supported by a computer program that is formed from computer readable program code and that is embodied in a computer readable medium. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory.

It may be advantageous to set forth definitions of certain words and phrases that have been used within this patent document. The term “couple” and its derivatives refer to any direct or indirect communication between two or more components, whether or not those components are in physical contact with one another. The terms “include” and “comprise,” as well as derivatives thereof, mean inclusion without limitation. The term “or” is inclusive, meaning and/or. The phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like.

While this disclosure has described certain embodiments and generally associated methods, alterations and permutations of these embodiments and methods will be apparent to those skilled in the art. Accordingly, the above description of example embodiments does not define or constrain this invention. Other changes, substitutions, and alterations are also possible without departing from the spirit and scope of this invention as defined by the following claims.

What is claimed is:

1. A method comprising:
receiving a first address over an address bus at a first module;
modifying the first address to generate a second address;
transmitting the second address over the address bus to a second module; and
determining at the first module if at least one of the first and second addresses has a specified value.

2. The method of claim 1, further comprising:
indicating that the first module is being selected when at least one of the first and second addresses has the specified value.

3. The method of claim 2, further comprising:
indicating that the first module is not being selected when a system enable/disable signal indicates that a system comprising the first module is disabled or not enabled;
indicating that the first module is not being selected when the system enable/disable signal indicates that the system is enabled and a board enable/disable signal indicates that the first module is disabled or not enabled; and
indicating that the first module is being selected regardless of the first address when an all enable/disable signal indicates that multiple modules including the first module are enabled.

4. The method of claim 1, wherein:
modifying the first address comprises decrementing the first address to generate the second address; and
determining if at least one of the first and second addresses has the specified value comprises determining if the first address has a value of zero.

5. The method of claim 1, wherein:
modifying the first address comprises incrementing the first address to generate the second address; and
determining if at least one of the first and second addresses has the specified value comprises determining if the first address has a value of 2ⁿ−1, where n is a specified number of bits in the address bus.

6. The method of claim 1, further comprising:
receiving the second address over the address bus at the second module;
modifying the second address to generate a third address;
transmitting the third address over the address bus to a third module; and
determining at the second module if at least one of the second and third addresses has the specified value.

7. The method of claim 1, further comprising:
transmitting the first address over the address bus from a controller;
wherein the first address identifies a position of a single specified module with respect to the controller.

8. A system comprising multiple modules coupled in series in a stack, each module configured to be selected over an address bus, each module comprising an addressing circuit configured to:
receive a first address over the address bus;
modify the first address to generate a second address;
transmit the second address over the address bus; and
determine if at least one of the first and second addresses has a specified value.

9. The system of claim 8, wherein the addressing circuit in each module is further configured to indicate that its associated module is being selected when at least one of the first and second addresses has the specified value.

10. The system of claim 9, wherein the addressing circuit in each module is further configured to:
indicate that the module is not being selected when a system enable/disable signal indicates that the system is disabled or not enabled;
indicate that the module is not being selected when the system enable/disable signal indicates that the system is enabled and a board enable/disable signal indicates that the module is disabled or not enabled; and
indicate that the module is being selected regardless of the first address when an all enable/disable signal indicates that the multiple modules are enabled.

11. The system of claim 8, wherein the addressing circuit in each module comprises:
adder circuitry configured to decrement the first address to generate the second address; and
logic circuitry configured to indicate whether the first address has a value of zero.

12. The system of claim 8, wherein the addressing circuit in each module comprises:
adder circuitry configured to increment the first address to generate the second address; and
logic circuitry configured to indicate whether the first address has a value of 2ⁿ−1, where n is a specified number of bits in the address bus.

13. The system of claim 8, further comprising:
a controller configured to communicate multiple addresses over the address bus, each of the multiple addresses identifying a position of one of the modules with respect to the controller.

14. The system of claim 13, wherein each module is configured to be inserted into any position in the stack relative to the controller and to be selected by the controller without manual configuration of the address assigned to that module.

15. The system of claim 8, wherein:
each module is configured to monitor at least one of multiple strings of photovoltaic panels; and
the system further comprises a power supply module configured to tap power from at least one of the strings of photovoltaic panels.

16. An apparatus comprising:
at least one interface configured to receive a first address over an address bus; and
an addressing circuit configured to modify the first address to generate a second address, transmit the second address to an external module via the at least one interface, and determine if at least one of the first and second addresses has a specified value.

17. The apparatus of claim 16, wherein the addressing circuit is further configured to indicate that the apparatus is being selected when at least one of the first and second addresses has the specified value.

18. The apparatus of claim 16, wherein the addressing circuit comprises:
adder circuitry configured to decrement the first address to generate the second address; and
logic circuitry configured to indicate whether the first address has a value of zero.

19. The apparatus of claim 16, wherein the addressing circuit comprises:
adder circuitry configured to increment the first address to generate the second address; and
logic circuitry configured to indicate whether the first address has a value of 2ⁿ−1, where n is a specified number of bits in the address bus.

20. The apparatus of claim 16, wherein the addressing circuit is configured to:
indicate that the apparatus is not being selected when a system enable/disable signal indicates that a system comprising the apparatus is disabled or not enabled;
indicate that the apparatus is not being selected when the system enable/disable signal indicates that the system is enabled and a board enable/disable signal indicates that the apparatus is disabled or not enabled;
indicate that the apparatus is being selected regardless of the first address when an all enable/disable signal indicates that multiple apparatuses are enabled; and
suppress jitter in an output of the apparatus when new addresses are received over the address bus.
